(19) United States
(12) Patent Application Publication
(10) Pub. No.: US 2007/0141424 A1
(43) Pub. Date: Jun. 21, 2007

(54) Solid oxide fuel cell and stack configuration

(76) Inventors: Timothy R. Armstrong, Clinton, TN (US); Michael P. Trammell, Jacksboro, TN (US); Joseph A. Marasco, Kingston, TN (US)

Correspondence Address: UT-Battelle, LLC;Office of Intellectual Property, One Bethal Valley Road, 4500N, MS-6258, Oak Ridge, TN, 37831, US

(21) Appl. No.: 11/314,111

(22) Filed: Dec. 21, 2005

(51) Int. Cl. H01M 8/12; H01M 8/24

(52) U.S. Cl. 429/32; 429/31; 429/38

(57) ABSTRACT

A fuel cell unit includes an array of solid oxide fuel cell tube sheets having porous metallic exterior surfaces, interior fuel cell layers, and interior surfaces, and at least one header in operable communication with the array of solid oxide fuel cell tube sheets for directing a first reactive gas into contact with the porous metallic exterior surfaces and for directing a second reactive gas into contact with the interior surfaces, the header further comprising at least one busbar selected from the group consisting of an exterior busbar disposed in electrical contact with the porous metallic exterior surfaces and an interior busbar disposed in electrical contact with the interior surfaces.

### CROSS-REFERENCE TO RELATED APPLICATIONS

Specifically referenced is U.S. patent application Ser. No. 11/103,333 entitled “Stack Configurations for Tubular Solid Oxide Fuel Cells”, filed on Apr. 11, 2005, the entire disclosure of which is incorporated herein by reference.

The United States Government has rights in this invention pursuant to contract no. DE-AC05-00OR22725 between the United States Department of Energy and UT-Battelle, LLC.

### FIELD OF THE INVENTION

The present invention relates to stack configurations for solid oxide fuel cells (SOFC), and more particularly to stack configurations for SOFC having metallic support tube sheets with interior fuel cell membranes.

### BACKGROUND OF THE INVENTION

Devices commonly known as fuel cells comprise plates or tubes that directly convert to electricity the energy released by oxidation of hydrogen. Fuel cells offer the potential for a clean, quiet, and efficient power source for portable electric generation. Solid oxide fuel cells (SOFC), particularly tubular solid oxide fuel cells (TSOFC), are particularly attractive candidates for applications in distributed or centralized power applications.

SOFC technology has the potential for providing high power densities, long, stable performance lifetimes, the ability to utilize a broad source of fuels without expensive reforming or gas cleanup, and provide high system efficiencies for a wide range of power generation for transportation.

Critical limitations of the current state of SOFC technology such as long start-up times (generally many minutes to hours) and high cost of materials manufacture have significantly impacted consideration thereof for automotive applications.

OBJECTS OF THE INVENTION

Accordingly, objects of the present invention include: provision of SOFC configurations that minimize the use of costly materials, minimize manufacturing costs, minimize startup times, and maximize power generation efficiency. Further and other objects of the present invention will become apparent from the description contained herein.

SUMMARY OF THE INVENTION

In accordance with one aspect of the present invention, the foregoing and other objects are achieved by a fuel cell unit that includes an array of solid oxide fuel cell tube sheets having porous metallic exterior surfaces, interior fuel cell layers, and interior surfaces, and at least one header in operable communication with the array of solid oxide fuel cell tube sheets for directing a first reactive gas into contact with the porous metallic exterior surfaces and for directing a second reactive gas into contact with the interior surfaces, the header further comprising at least one busbar selected from the group consisting of an exterior busbar disposed in electrical contact with the porous metallic exterior surfaces and an interior busbar disposed in electrical contact with the interior surfaces.

### BRIEF DESCRIPTION OF THE DRAWINGS

FIG. 1 is an oblique, not-to-scale view of a portion of a fuel cell tube sheet in accordance with an embodiment of the present invention.

FIG. 2 is an oblique, not-to-scale view of a portion of a fluted fuel cell tube sheet in accordance with an embodiment of the present invention.

FIG. 3a is a schematic end view of a fuel cell tube sheet assembly in accordance with an embodiment of the present invention.

FIG. 3b is a schematic end view of a fuel cell tube sheet assembly in accordance with an embodiment of the present invention.

FIG. 3c is a schematic end view of a fuel cell tube sheet assembly in accordance with an embodiment of the present invention.

FIG. 3d is a schematic end view of a fuel cell tube sheet assembly in accordance with an embodiment of the present invention.

FIG. 4a is an oblique, exploded view of a fuel cell assembly in accordance with an embodiment of the present invention.

FIG. 4b is a magnification of part of the fuel cell assembly shown in FIG. 4a.

FIG. 5 is an oblique view of a fuel cell assembly in accordance with an embodiment of the present invention.

FIG. 6 is an oblique, exploded, partial view of a fuel cell assembly in accordance with an embodiment of the present invention wherein the tube sheets are connected in parallel.

FIG. 7 is an oblique, cutaway, partial view of the fuel cell assembly shown in FIG. 6.

FIG. 8 is an oblique view of a header in accordance with an embodiment of the present invention wherein the tube sheets are connected in series.

FIG. 9 is an oblique view of the other side of the header shown in FIG. 8.

FIG. 10 is an oblique view of a header of the other end of a fuel cell assembly from the header shown in FIG. 8.

FIG. 11 is an oblique view of the other side of the header shown in FIG. 10.

FIG. 12 is an axial cutaway top view through an assembled tube sheet and header in accordance with an embodiment of the present invention.

Equivalent elements in the figs. are identified with like numerals.

For a better understanding of the present invention, together with other and further objects, advantages and capabilities thereof, reference is made to the following disclosure and appended claims in connection with the above-described drawings.

### DETAILED DESCRIPTION OF THE INVENTION

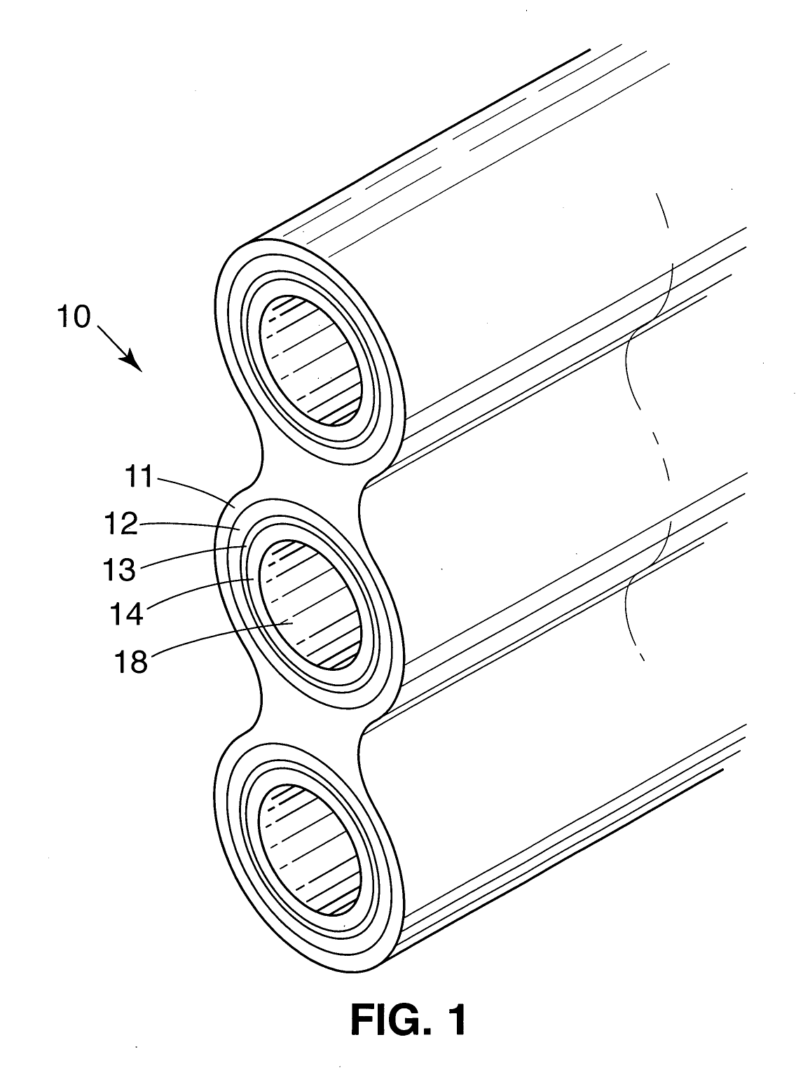

The present invention improves SOFC by using a combination of an exterior, preferably metallic support structure and interior membranes in unique stack configurations. Referring to FIG. 1, an example of a SOFC tube sheet 10 defines an array of integral, generally cylindrical openings 18 having annular cross-sections. The tube sheet 10 can be comprised of any robust, porous, conductive material, preferably metallic. The tube sheet 10 can be made by any conventional means such as molding, extrusion, casting, forging, isostatic compression, etc. The tube sheet should be open on both ends; the openings 18 pass completely therethrough.

Each generally cylindrical opening 18 defined by the tube sheet 10 is coated on the inside thereof with a porous anode 12 such as Ni—Ni Yttria stabilized zirconia (YSZ), for example. The anode 12 is coated on the inside with a dense electrolyte 13 such as Y₂O₃—ZrO₂, for example. The dense electrolyte 13 is coated on the inside with a porous cathode 14 such as LaMnO3, for example. The compositions used to make the SOFC tube sheet are not critical to the present invention. Moreover, the anode and cathode layers can be interchanged.

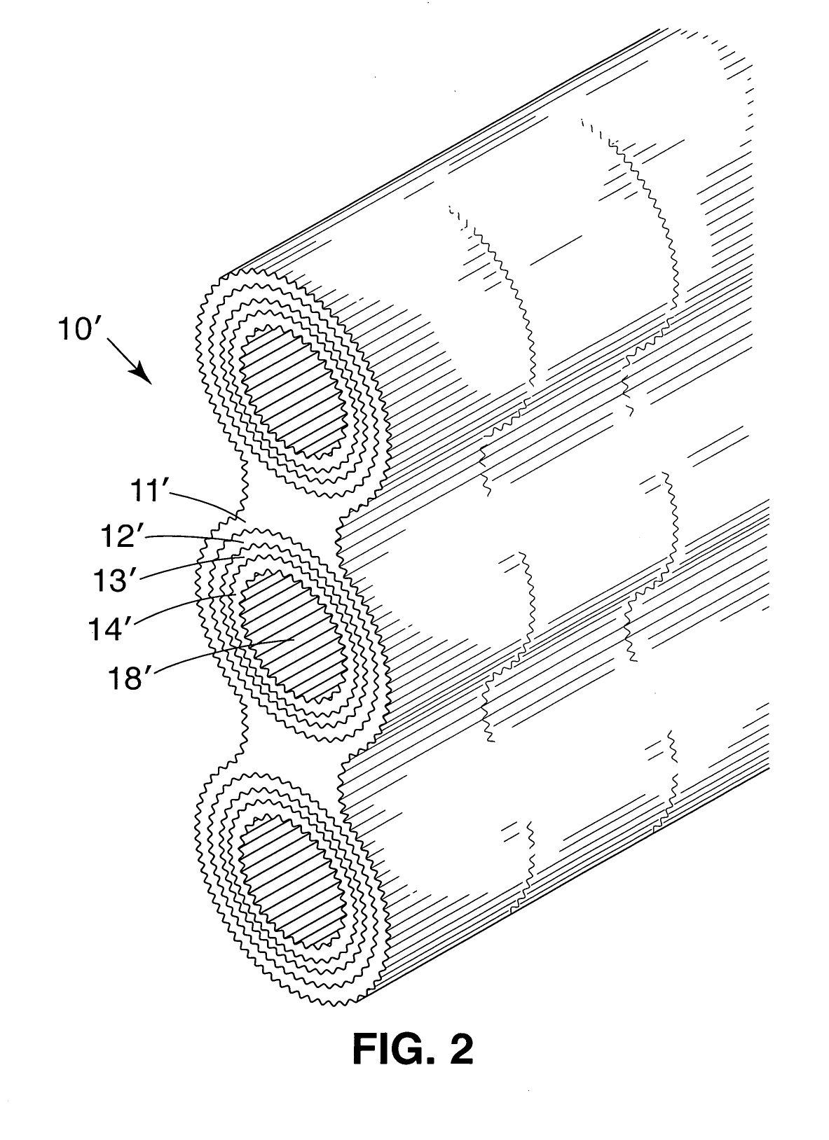

The cross-sectional shape of the tube sheet 10 and the openings 18 defined thereby are not critical to the invention, although some shapes will be found to be more beneficial, especially those shapes which promote contact of reactive gases with respective surfaces of the tube sheet 10. Referring to FIG. 2, an example of a differently shaped SOFC tube sheet 20 shows that inner and/or outer surfaces 22, 24 can have wavy shape that increases surface area and promotes turbulence of reactive gases.

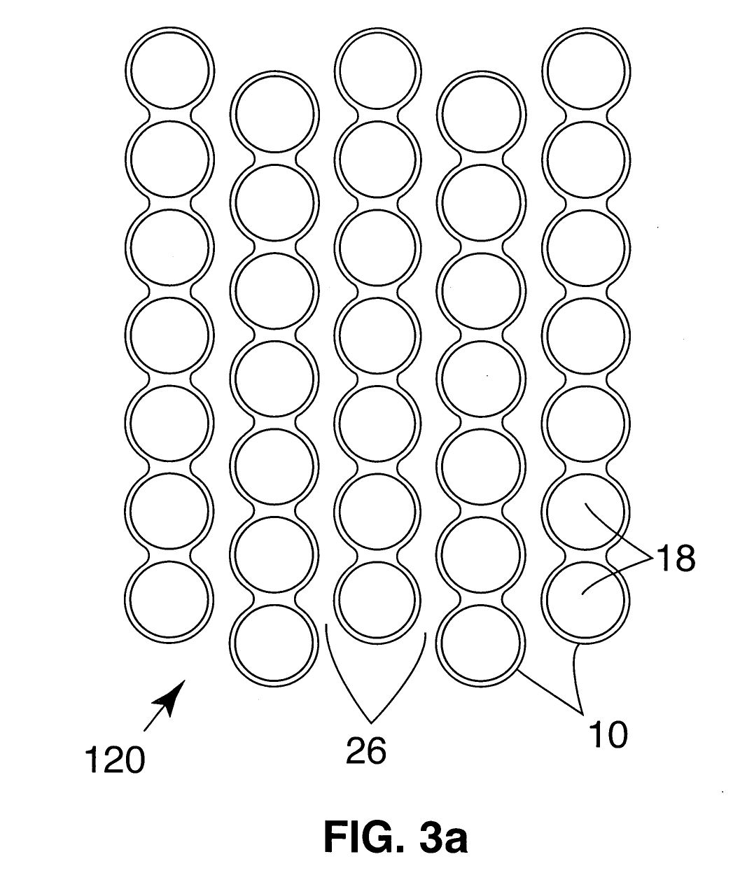

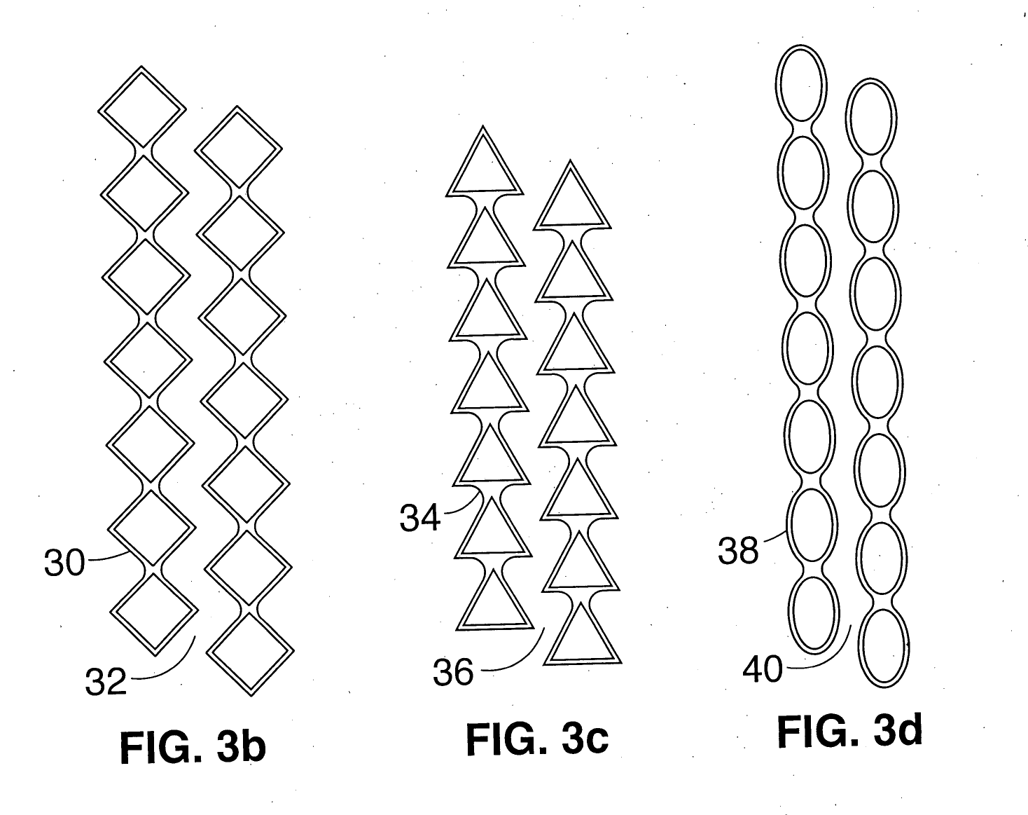

FIG. 3a shows an embodiment of the invention wherein tube sheets 10 are arranged in a stack 120 having a staggered configuration, being separated by serpentine gaps 26 that promote turbulence of reactive gases flowing therethrough. A non-staggered arrangement may also be suitable. Although nonlinear gaps 26 are preferable, embodiments of the invention with linear gaps would also be operable.

The shapes of the tube sheets and gaps therebetween are infinitely variable in accordance with the present invention. For example, FIGS. 3b, 3c, and 3d show, respectively, embodiments of the invention having tube sheets 30, 34, 38 having various shapes, thereby defining gaps 32, 36, 40 that are of different shapes.

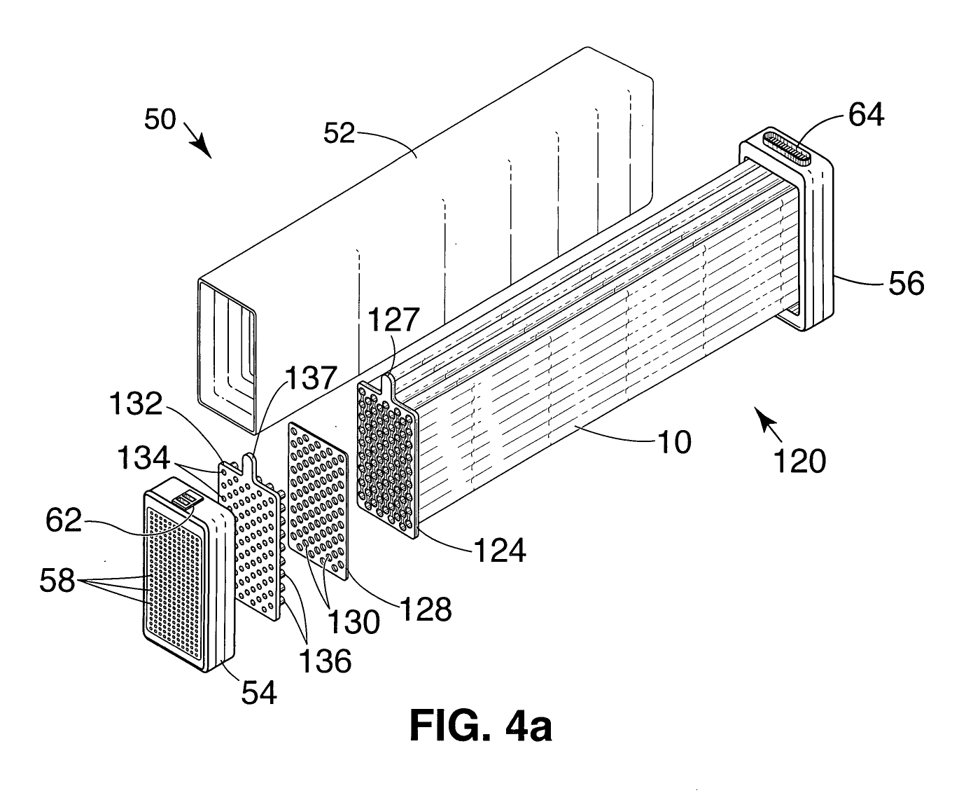

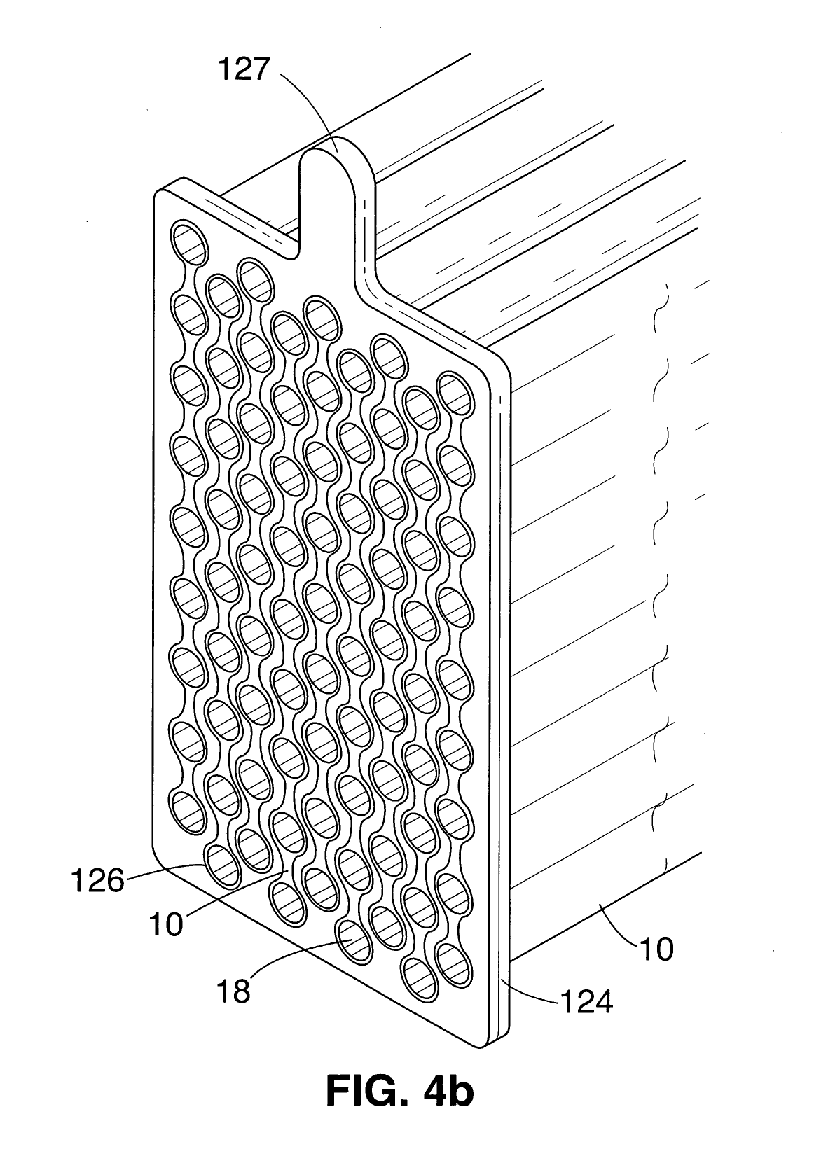

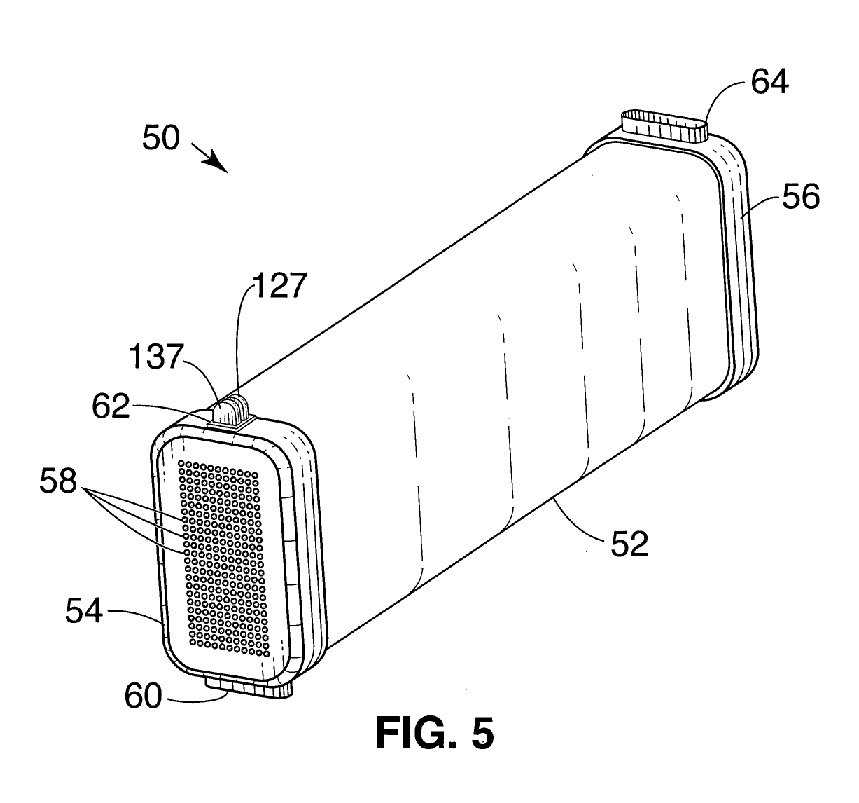

Referring to FIGS. 4a, 4b, and 5, the tube sheets 10 can be arranged in a stack 120 in a SOFC unit 50. The SOFC unit 50 comprises a housing (case) 52 and end caps 54, 56. An intake end cap 54 has air intake openings 58 to admit air into the unit 50, a fuel inlet 60, and an electrical terminal port 62, generally including a seal and/or electrical insulation. An exhaust end cap 56 has a fuel exhaust port 64 and air exhaust openings similar to the air intake openings 58. The intake end cap 54 and exhaust end cap 56 can be identical except for accommodation of the interior electrical terminal port 62, which can be located wherever it may be convenient, such as at either or both end caps 54, 56. The tube sheets 10 are held in respective positions in the SOFC unit 50 by the components at each end thereof, which are described hereinbelow.

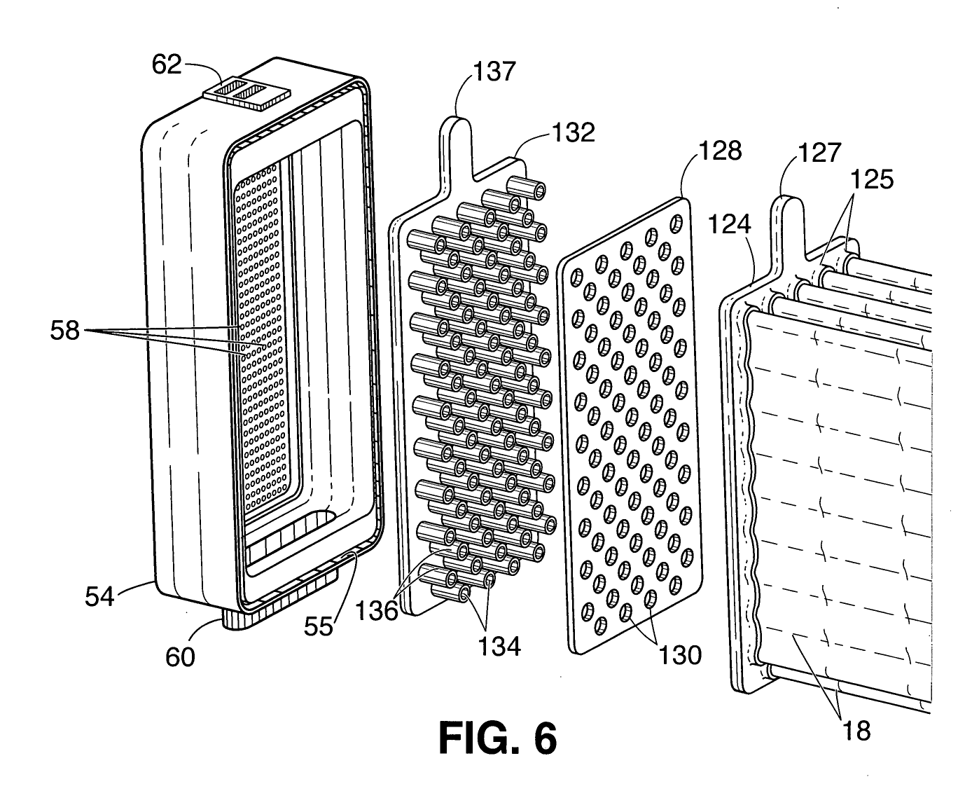

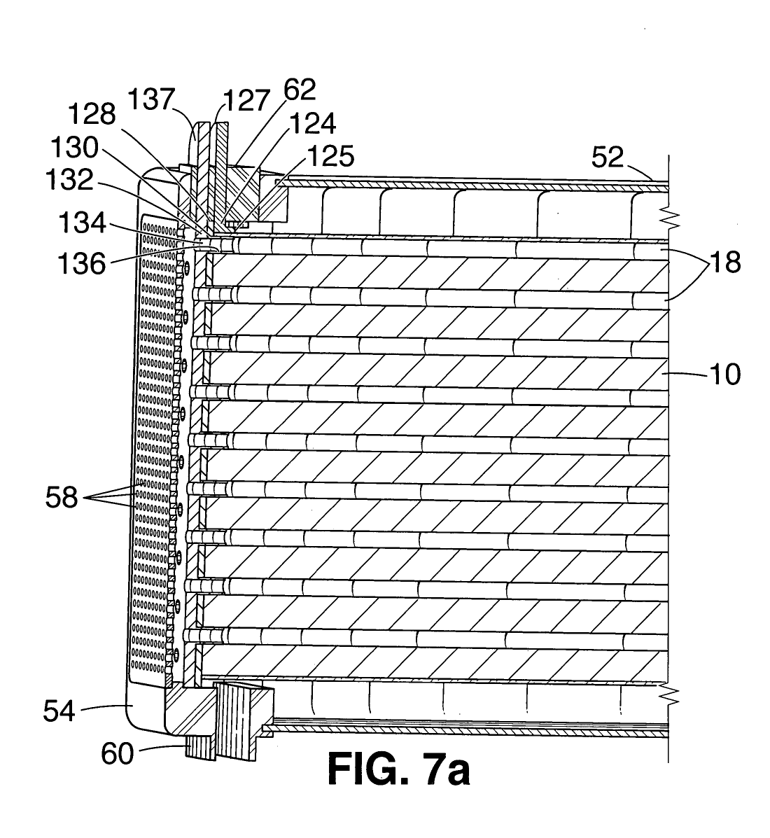

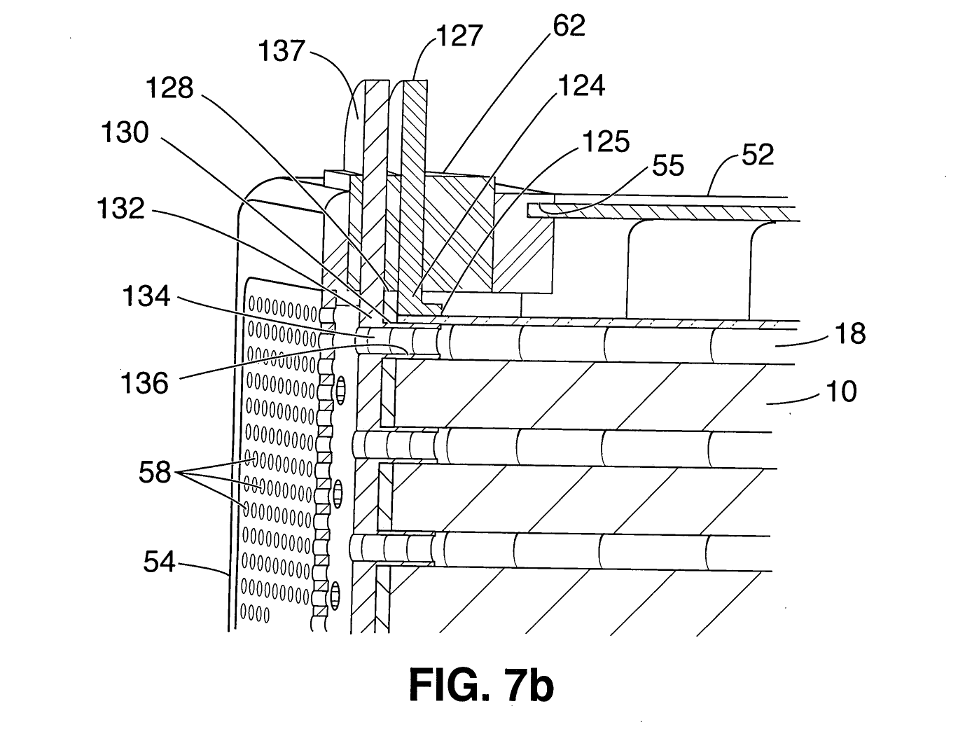

FIGS. 4a, 4b, 5, 6, 7a, and 7b show embodiments of the invention wherein the tube sheets 10 are interconnected in parallel fashion. The stack 120 of tube sheets 10 is enclosed on each end by a support means that can include various functional components. The first such component is an exterior busbar 124 that is in electrical communication with the outer, metallic components of the tube sheets 10. The exterior busbar 124 has slot-shaped openings 126 that fit and align with the tube sheets 10 for allowing air to enter the openings 18 therethrough. The exterior busbar 124 can have posts, wings, flanges, or other type of extensions 125 that are associated with the openings 126 and extend over the tube sheets 10 and contact the exterior surfaces thereof of to provide electrical communication therewith. The exterior busbar 124 can be brazed, welded, press-fit, or otherwise robustly attached onto each tube sheets 10 in order to hold the stack 120 together and/or provide dependable electrical connection. Other plates (not illustrated) similar in shape to the exterior busbar 124, either conducting or non-conducting, can be used to support the tube sheets 10 between the ends thereof. The exterior busbar 124 can have an integral terminal 127 such as a tab, prong, or post, for example.

The next component is an insulator 128 having openings 130 that align with the tube sheets 10 for allowing air to enter the openings 18 therethrough. The insulator 128 seals against the exterior busbar 124.

The next component is an interior busbar 132 having openings 134 that align with the tube sheets 10 for allowing air to enter the openings 18 therethrough. The interior busbar 132 seals against the insulator 128, which prevents electrical contact between the exterior busbar 124 and the interior busbar 132. The interior busbar 132 has posts, wings, flanges, or other type of extensions 136 that are associated with the openings 134 and extend into the openings 18 and contact the interior surfaces of the tube sheets 10 to provide electrical communication therewith. The interior busbar 132 can be brazed, welded, press-fit, or otherwise robustly attached into each tube sheet 10 in order to hold the stack 120 together and/or provide dependable electrical connection. The interior busbar 132 can have an integral terminal 137 such as a tab, prong, or post, for example.

The next component is an end cap 54 which is either insulating or includes an insulating (i.e., electrically insulating) inner liner to prevent electrical contact and subsequent shorting of the busbars 124, 132. The end cap 54 can have an insulating terminal support 62 to accommodate the terminals 127, 137. The insulating terminal support 62 can be a grommet, an interlocking connector, or any other structure that provides at least one of ease of assembly, terminal support, insulation, reinforcement, and fastening. The end cap 54 can have a groove 55 or other means for sealable attachment to the housing 52.

The exterior busbar 124, insulator 128, and interior busbar 132 can be integrated into a single component having a plurality of layers. The insulator can serve as a support for the tube sheets 10, and can have conductive (for example, metal) coatings on either side to serve as busbars 124, 132.

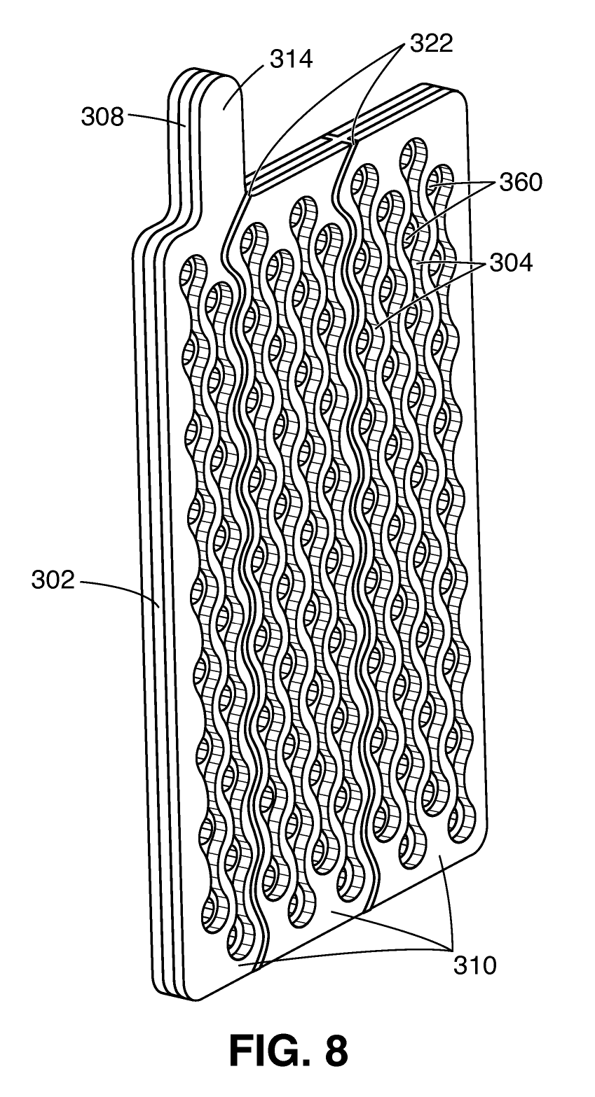

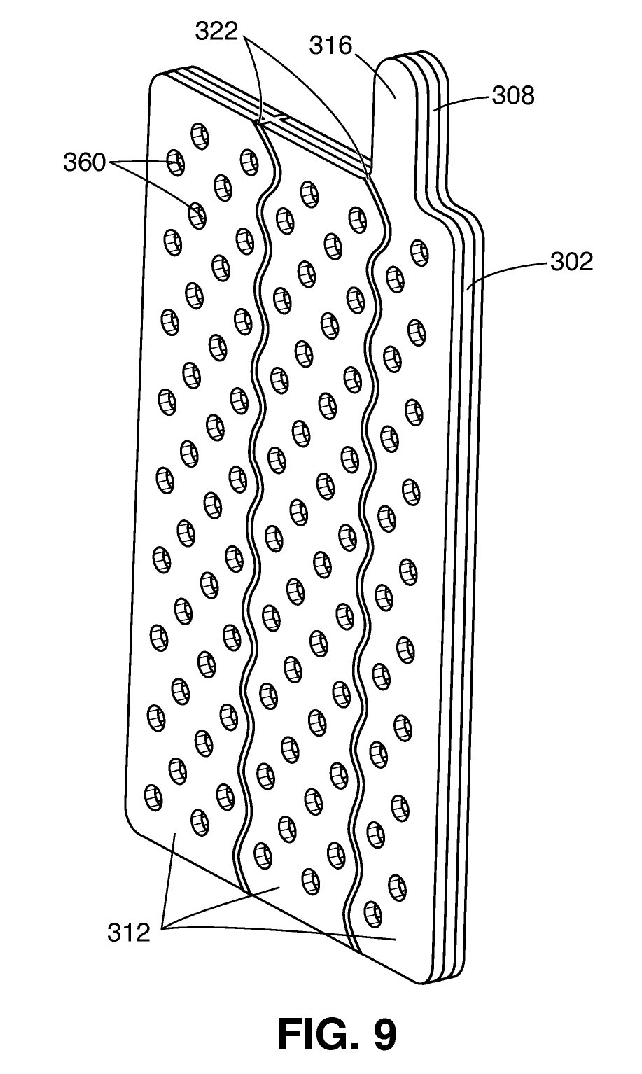

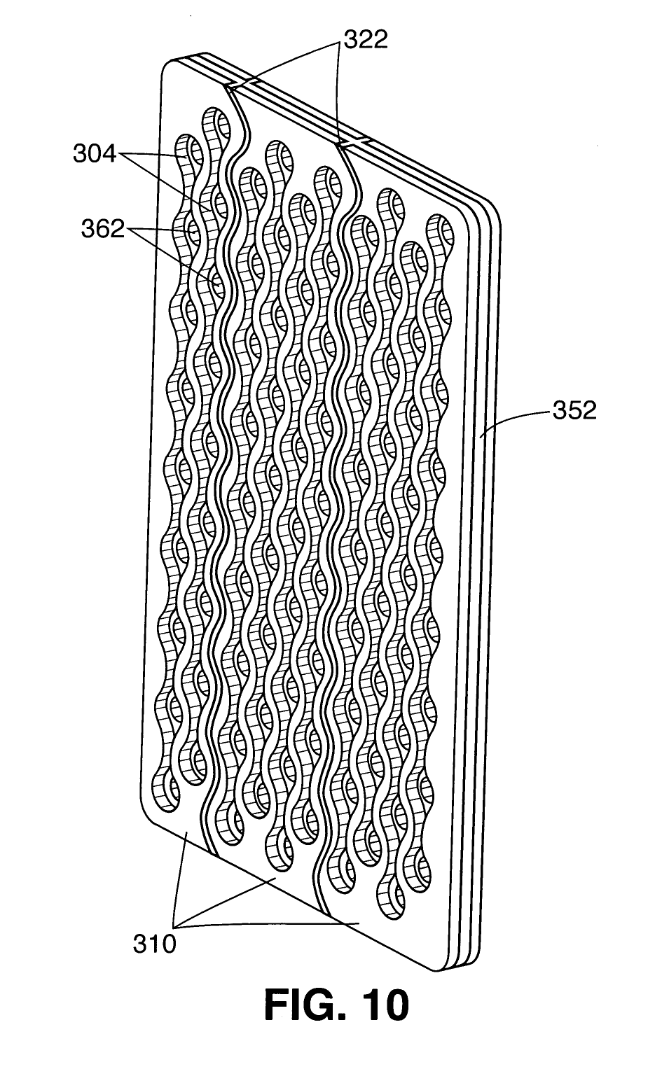

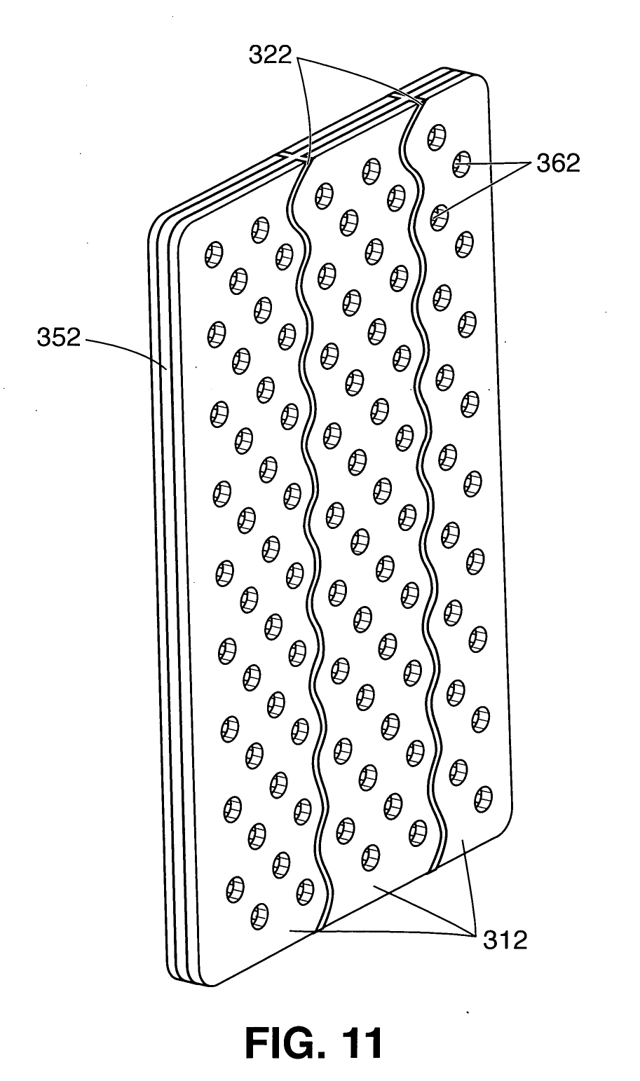

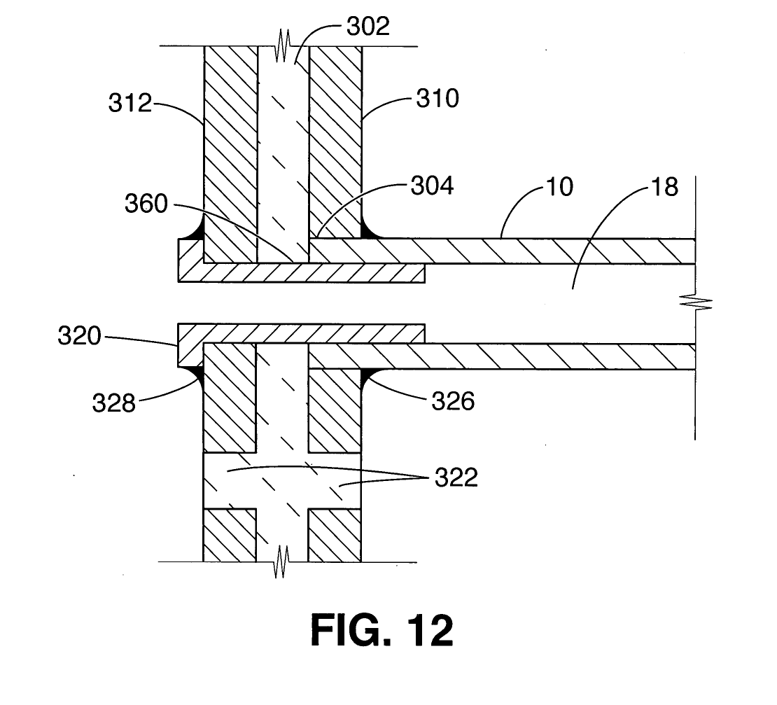

FIGS. 8-12 show an embodiment of the invention wherein the tube sheets 10 are interconnected in series fashion. Robust, insulating support plates 302, 352, support the tube sheets 10 on either end of the stack. At least one of the insulating support plates further includes accommodation of an electrical terminal; a terminal tab 308 is used in the example shown. The insulating support plates 302, 352, have holes 360, 362 respectively, that align with the openings 18 in the tube sheets 10 for allowing air to enter therethrough

Exterior busbars 310 and interior busbars 312 are adherently disposed on respective sides of the support plates 302, 352 in patterns with insulated separation ribs 322 as shown that connect the tube sheets 10 in series and parallel as desired. The patterns shown connect the tube sheets 10 in parallel vertical stacks which are connected in series horizontally. The exterior busbars 310 and interior busbars 312 extend over respective sides of the terminal tab 308 to provide respective external electrical connections 314, 316 to a mating connector (not illustrated).

The tube sheets 10 fit into slots 304 in the exterior and interior busbars 310 and abut the support plates 302, 352. Solder joints 326 can be used to fasten the exterior busbars 310 to the exteriors of the tube sheets 10 and provide electrical connection thereto. Hollow pins such as rivets 320 can be used to pass through the holes 304 and provide electrical connection to the interiors of the tube sheets 10. Solder joints 328 can be used to fasten the rivets 320 to the interior busbars 312.

The skilled artisan will recognize that fuel and air inlets described above are of a typical nature, and can be of any suitable size, shape, configuration, and/or location on the unit. Moreover, the skilled artisan will recognize that electrical terminals described in all of the embodiments above are of a typical, conventional nature, and can be of any suitable size, shape, configuration, and/or location on the unit. The terminals can be battery posts or can be incorporated into one or more electrical plugs, connectors, sockets, and/or the like. The terminals can be connected to the current collectors by any suitable conventional means, such as, for example, wires, plates, strips, and the like.

Features of the present invention provide advantages of sealing as the metallic support allows for the use of brazes and welds.

While there has been shown and described what are at present considered the preferred embodiments of the invention, it will be obvious to those skilled in the art that various changes and modifications can be prepared therein without departing from the scope of the inventions defined by the appended claims.

What is claimed is:

1. A fuel cell unit comprising:
a. an array of solid oxide fuel cell tube sheets having porous metallic exterior surfaces, interior fuel cell layers, and interior surfaces; and
b. at least one header in operable communication with said array of solid oxide fuel cell tube sheets for directing a first reactive gas into contact with said porous metallic exterior surfaces and for directing a second reactive gas into contact with said interior surfaces, said header further comprising at least one busbar selected from the group consisting of an exterior busbar disposed in electrical contact with said porous metallic exterior surfaces and an interior busbar disposed in electrical contact with said interior surfaces.

2. A fuel cell unit in accordance with claim 1 wherein said header supports said array of solid oxide fuel cell tube sheets.

3. A fuel cell unit in accordance with claim 1 wherein said header is integral with said exterior busbar.

4. A fuel cell unit in accordance with claim 1 wherein said header supports said exterior busbar.

5. A fuel cell unit in accordance with claim 3 wherein said header is integral with said interior busbar.

6. A fuel cell unit in accordance with claim 1 wherein said header supports said interior busbar.

7. A fuel cell unit in accordance with claim 1 wherein said solid oxide fuel cell tube sheets are electrically connected to each other in parallel.

8. A fuel cell unit in accordance with claim 1 wherein said solid oxide fuel cell tube sheets are electrically connected to each other in series.

9. A fuel cell unit in accordance with claim 8 wherein said interior busbar further comprises a plurality of interior busbar components.

10. A fuel cell unit in accordance with claim 9 wherein said header further comprises an insulating material that supports said interior busbar components.

11. A fuel cell unit in accordance with claim 8 wherein said exterior busbar further comprises a plurality of exterior busbar components.

12. A fuel cell unit in accordance with claim 11 wherein said header further comprises an insulating material that supports said exterior busbar components.
